(19) United States
(12) Patent Application Publication
(10) Pub. No.: US 2016/0009984 A1
(43) Pub. Date: Jan. 14, 2016

(54) NOVEL VISCOUS FLUIDS SYSTEMS FROM PRODUCED AND FLOW BACK WATERS

(71) Applicant: Trican Well Service, Ltd., Calgary (CA)

(72) Inventors: Joseph Earl Thompson, Houston, TX (US); Sarkis R. Kakadjian, The Woodlands, TX (US)

(73) Assignee: TRICAN WELL SERVICE, LTD., Calgary (CA)

(21) Appl. No.: 14/796,637

(22) Filed: Jul. 10, 2015

Related U.S. Application Data
(60) Provisional application No. 62/023,113, filed on Jul. 10, 2014.

(51) Int. Cl. C09K 8/66

(52) U.S. Cl. CPC C09K 8/665

(57) ABSTRACT

In certain instances high levels of boron is present in produced or flowback water after it has been treated. The boron or borates tend to cause the guar to cross-link and become viscous too early which may cause undue wear or other problems with the surface equipment. It has been found that in the presence of low pH the viscosifier typically does not cross-link in the presence of a borate allowing the finished water to be used to hydrate the fluid. The fluid including the now hydrated linear gel is then subject to a chelating process so that the boron may be sequestered. Once the originally present borate is sequestered a slowly soluble borate is added to cause the linear gel to cross-link at the desired point in time.

### CROSS-REFERENCE TO RELATED APPLICATIONS

This application claims priority to U.S. Provisional Patent Application No. 62/023,113 that was filed on Jul. 10, 2014.

### BACKGROUND

Hydraulic fracturing is a common and well-known enhancement method for stimulating the production of hydrocarbon bearing formations. The process involves injecting fluid down a wellbore at high pressure. The fracturing fluid is typically a mixture of water and proppant. The proppant may be made of natural materials or synthetic materials.

Generally the fracturing process includes pumping the fracturing fluid from the surface through a tubular. The tubular is prepositioned in the wellbore to access the desired hydrocarbon formation. The tubular is then sealed both above and below the formation to isolate fluid flow either into or out of the desired formation and to prevent unwanted fluid loss. Pressure is then provided from the surface to the desired hydrocarbon formation in order to open a fissure or crack in the hydrocarbon formation.

Typically large amounts of water are required in a typical hydraulic fracturing operation. Additionally, chemicals are often added to the fluid along with proppant to aid in proppant transport, friction reduction, wettability, pH control, bacterial control, and other wellbore issues. Typically, the fluid is mixed with the appropriate chemicals and proppant particulates and then pumped down the wellbore and into the cracks or fissures in the hydrocarbon formation.

The demand for water to be used in hydraulic fracturing of hydrocarbon producing reservoirs is ever increasing. For example, unconventional gas such as gas shale formations requires multiple large slick water fracturing stimulations applied to horizontal wells in order to enable the recovery of this resource. To meet these demands, it is desirable to use otherwise unusable water such as produced water, flowback water, or discharge water from industrial processes.

Operators have begun to use on-site water treatment processes. In many instances such on-site water treatment utilizes a settling tank. The water in such settling tanks may be treated with pH modifiers and flocculants. The water may then be subjected to electro-coagulation along with some type of biocide, then an additional treatment to remove remaining particulants. Unfortunately such treatment doesn't always remove all of the chemicals that may be present in the finished water. In many instances such finished water may have excessive boron concentrations. Unfortunately boron and its derivatives are used in many instances as the cross-linking agent for guar and its derivatives. The high levels of boron that may be present in the finished processed water tend to limit adequate guar hydration. Excessive boron in the water will cause the guar to cross-link prematurely and become viscous too early in the fracturing process. This will limit fracturing design injection rates. In addition, premature crosslinking of polymer solution will cause subsequent surface treating pressures to exceed well pressure limits. These types of pressure issues are significantly increased in scenarios where the crosslinked fracturing fluid composition, as mentioned above, is injected down well annulus. The finished processed waters having high levels of boron have not been suitable for use as fracturing base water.

### SUMMARY

As envisioned in a current embodiment of the present invention, produced or flowback water, that after an initial treatment to remove particulates and most of the minerals and chemicals but still having a high boron concentration, may be used as a delayed crosslinking fracturing fluid.

In an embodiment of a delayed crosslink fracturing fluid a finished flowback or produced water is used. Initially the method begins by hydrating the polymer and modifying the pH to keep the pH of the fluid below about 7 pH in order to prevent the boron from interacting with the polymer at this juncture. To hydrate the polymer, a dry or slurried guar polymer is dispersed in the process stream at the proper concentration, into a metered stream of the finished water. The boron in the fluid is then chelated to prevent the boron that is initially present from causing the hydrated polymer from cross-linking until appropriate. Once the boron has been sequestered, or chelated, the fluid must be prepared to allow the fluid to cross-link at the appropriate time. Therefore, prior to pumping the fluid downhole, the pH of the fluid is now increased to above 7 pH. Then a sparingly soluble material containing boron is added, and in some instances, along with a more readily soluble boron. Such a system will take the finished water and bind the boron so that the boron does not cause the guar to crosslink too early. As the fluid is pumped downhole, the fluid will optimally not begin to crosslink until the fluid leaves the vertical section of the well. However once the fluid enters the horizontal section of the well it is desirable for the fluid to begin to cross-link in order to keep the proppant in suspension.

One method of overcoming the difficulties of utilizing finished water having high levels of boron is to begin by pumping the finished water derived from produced or flowback water into a hydration unit where a bactericide, such as 2, 2-dibromo-3-nitrilopropionamide, may be added. A low pH hydration buffer such as ammonium acetate and acetic acid is added at a concentration that would provide a fluid pH below 7. A dry or slurried guar polymer may also be dispersed at the proper concentration, into a metered stream of the finished water. Generally these additions are made in close proximity each other, and behind the centrifugal pump to assure uniform dispersion into the finished processed water.

Typically, the hydration buffer should be added at a concentration that will control the pH of the polymer, produced water, and bactericide mixture so that the pH of the fluid is below a pH of about 7. Typically a low pH buffer system, such as acetic acid or ammonium acetate, is used to keep the overall pH of this fluid between 6 and 6.5. Other Acids or acid solution blends like acetic acid or anhydride acetic, or blends of these two, for example, can be used to titrate pH of the finished produced or flow back water to the desired pH levels. Keeping the pH between 6 and 6.5 avoids having to add excessive amounts of hydration buffer to lower the pH when it is necessary to hydrate the viscosifier. Initially maintaining the pH between 6 and 6.5 appears to give the best hydration profile at the lowest acid delivery while not causing polymer premature crosslinking with the boron in solution. At this point a pH above 7 will cause the hydrating polymer to begin to cross-link and potentially causing metering issues along with an eventual a shut down due to excessive surface treating pressure at the frac design pump injection rate.

When the polymer has “hydrated” in the hydration unit, the fluid is then pumped into the continuous mix fracturing fluid stream where a chelating agent is metered into the hydrated linear gel in the continuous mix fracturing fluid stream after the fluid exits from the hydration unit. The chelating agent sequesters the boron in the hydrated linear gel. The chelating agent delays the boron from activating the cross-linking with the guar. The amount of chelating agent is varied depending upon whether a faster or slower crosslink time is desired, or, changes in the fluid temperature. The chelating agent may be a blend of polyols selected from the group consisting of glycol like ethylene or propylene glycol, polyhydroxy saccharides like sorbitol, esters, and other polysaccharides. The term polyol is understood to mean an organic compound having adjacent or vicinal (geminal) alcohol (hydroxide) moieties. The chelating agent is used to sequester the boron in the hydrated linear gel and delay the borate cross-link. The metering rate of this composition can be increased or decreased if a faster or slower cross-link time is required for the job or if hydrated fluid temperature changes.

A high pH control additive is then added to the continuous mix fracturing fluid stream. The high pH control additive allows the boron chelation reaction in the continuous mix fracturing fluid stream to be more effective by adjusting the pH of the mixture above 7. The high pH control additive also stabilizes the viscosity of the fracturing fluid by creating more borate ions suitable for cross-linking. The range of adjusted pH should be from about 8.0 to about 12. The preferred pH range for crosslinking is from about 10 to about 11. The high pH control additive material is typically a blend of potassium hydroxide and potassium carbonate. Other high pH control additives are a useful in this invention, including alkanol amines, primary, secondary, and tertiary amines

Once the high pH control additive is mixed into the continuous mix fracturing fluid stream, a delayed crosslinker is added to the continuous mix fracturing fluid stream. This delayed crosslinker is generally a slurried suspension of a finely ground borate ore such as ulexite or other sparingly soluble boron derivative such as sodium calcium borate. As the temperature of fluid increases, for instance as the fluid is pumped deeper into a well, the solubility rate of the sparingly soluble boron derivative will increase. In certain instances a small amount of a borax solution may be added to the fluid if a faster crosslink time is desired for the fluid.

Surfactants, non-emulsifiers, proppants, breakers, or other desired substances may also be metered into the fracturing fluid process stream. The concentration of any of these additives could change depending on the formation mineralogy and formation fluids compatibility with frac fluid system formulated with the finished treated water that has been processed.

### BRIEF DESCRIPTION OF THE DRAWINGS

FIG. 1 is a graph of the viscosity of the mixture having 4 gallons per thousand of chelant and 6 gallons per thousand 11 alkyl mixture.

FIG. 2 is a graph of the viscosity of the mixture having 3.5 gallons per thousand of chelant.

FIG. 3 is a graph of the viscosity of the mixture having no chelant.

FIG. 4 is a graph of the viscosity of the mixture having 4 gallons per thousand of chelant.

### DETAILED DESCRIPTION

The description that follows includes exemplary apparatus, methods, techniques, or instruction sequences that embody techniques of the inventive subject matter. However, it is understood that the described embodiments may be practiced without these specific details.

In an embodiment of the present invention where boron is present in the finished water it is necessary to sequester or chelate the boron to prevent the boron from causing the viscosifier from cross-linking too soon. When the polymer dispersion begins to cross-link too early, in some tubular geometries, the increase in viscosity makes the polymer dispersion difficult to pump downhole. Ideally the fluid containing the polymer will have a very low viscosity on the surface. and as the fluid is pumped down through the vertical section of a laterally drilled well. However, once the fluid begins to turn to a more horizontal orientation it is desirable for the fluid to become more viscous. This is necessary in order to provide higher viscosity for proppant transport through the well perforations and higher viscosity to create the desired fracture geometry.

If needed, initially a low pH buffer system may be added to the fluid. While any buffer system may be used acetic acid or ammonium acetate is preferred. By reducing the pH of the fluid the viscosifier, added after the low pH buffer is prevented from bonding with the boron and causing premature crosslinking of the fluid.

Present preferred gelling agents include guar gums, hydroxypropyl guar, carboxymethyl hydroxypropyl guar, and carboxymethyl guar. Other examples of such polymers include, without limitation, guar gums, high-molecular weight polysaccharides composed of mannose and galactose sugars, or guar derivatives such as hydropropyl guar (HPG), carboxymethyl guar (CMG) and carboxymethylhydropropyl guar (CMHPG).

Once the linear gel has been hydrated a chelating agent is added to sequester the boron that may prematurely cause the linear gelled fluid to cross-link.

Chelating agents or polyols may comprise such materials as glycols, glycerin, saccharides such as glucose, sorbitol, dextrose, mannose, mannitol and the like as well as other carbohydrates and polysaccharides including natural and synthetic gums. The chelating agent may be a blend of polyols such as glycols like ethylene or propylene glycol, polyhydroxy saccharides like sorbitol, esters, and other polysaccharides. The term “polyol” is understood to mean an organic compound having adjacent or vicinal alcohol (hydroxide) moieties including acids, acid salts, esters, and amine derivatives of a polyol.

The boron in the borate moiety present in the water can be chelated prior to its exposure to the hydrated polymer. As a result, there is a delay before sufficient borate is released from the chelate form to effect crosslinking.

Once the boron or borate is effectively sequestered or chelated during the hydration process, the pH of the fluid may then be raised. The high pH control additive allows the boron chelation reaction in the continuous mix fracturing fluid stream to be more effective by adjusting the pH of the mixture above 7. The high pH control additive allows the boron chelation reaction in the continuous mix fracturing fluid stream to be more effective by adjusting the pH of the mixture above 7 using a selection of alkali metal hydroxides. Also at the appropriate time when boron or borates are again available to cause the viscosifier to cross-link, the high pH control additive stabilizes the viscosity of the fracturing fluid by creating more borate ions suitable for cross-linking. The range of adjusted pH should be from about 8.0 to about 12. The preferred pH range for crosslinking is from about 10 to about 11.0. The high pH control additive material can be typically a blend of potassium hydroxide and potassium carbonate or amines such as alkanol amines, more specifically monoethanol amine, diethanol amine, diisopropanol amine, or 2-methylaminopropanol amine. The range of adjusted pH should be from about 8.0 to about 12. The preferred pH range for crosslinking is from about 10 to about 11. The high pH control additive material is typically a blend of water soluble alkali metal hydroxides and alkali metal carbonate like potassium hydroxide and potassium carbonate, or, sodium hydroxide and sodium carbonate.

At this stage while it continues to be desirable to delay the crosslinking of the hydrated fluid. The timing of when the crosslinker modifies the hydrated fluid may be adjusted. Typically it is preferred to have the hydrated fluid cross-link, or become more viscous, as the fluid leaves the vertical section of the well and enters the more or less horizontal section of the well. A method of delaying crosslinking, including at high temperatures, involves the addition of slowly soluble boron compounds, or “matrix particles” of a borate compound combined with an agent that interferes with borate dissolution. This delayed crosslinker is generally a slurried suspension of a finely ground borate ore such as ulexite, colemanite, or other sparingly soluble boron derivative such as sodium calcium borate. The agent in which the finely ground borates are “slurried” or dispersed in hydrocarbons like diesel or mineral oil. The finely ground borates are sometimes formulated in water based carriers.

As the temperature of fluid increases, for instance, as the fluid is pumped deeper into a well, the solubility rate of the sparingly soluble boron derivative will increase. In certain instances a small amount of a borax solution may be added to the fluid if a faster crosslink time is desired for the fluid.

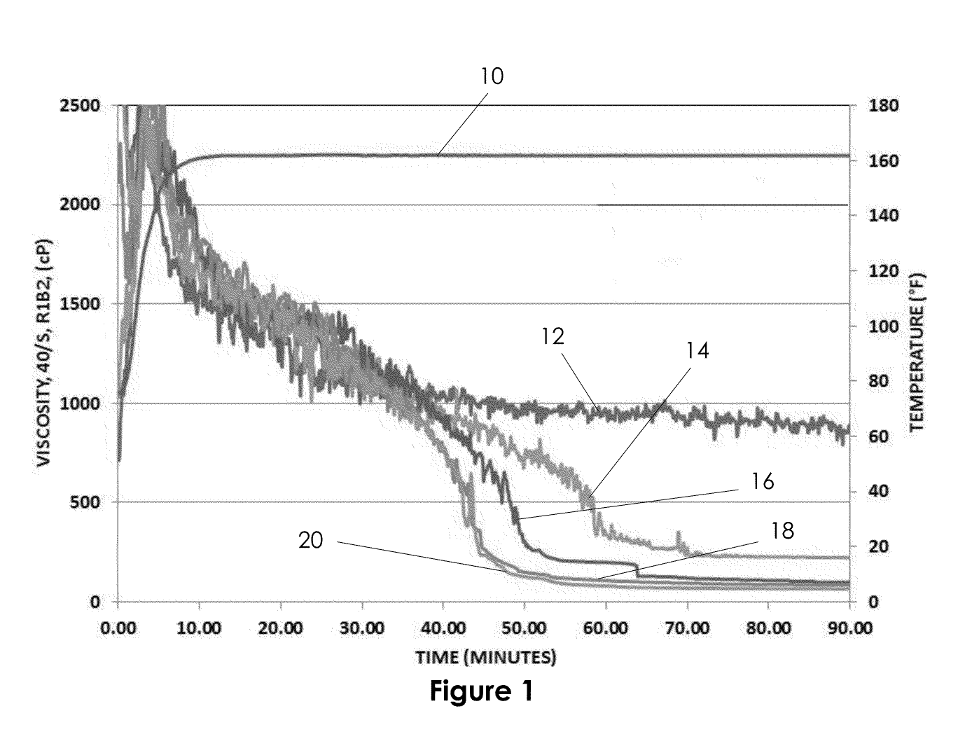

FIGS. 1 through 4 are graphs using varying amounts of different additives based upon the test procedure as follows. To the initial water a pH buffer, such as an ammonium acetate and acetic acid blend, and the polymer, typically a guar polymer slurry having 4 pounds of guar per gallon of mineral oil, is added. Allow six minutes for polymer hydration. The chelating agent is then added. Typically the chelating agent is a mixture of glycerol, ethylene glycol, and sorbitol. Next a pH booster is added. Typically the pH booster is a mixture of potassium hydroxide and potassium carbonate. Then the boron ore, such as ulexite, along with a small amount of boron booster such as a 25% potassium borate solution is added to the mixture. Finally a delayed breaker is added. Then the viscosity is test is run showing that the produced water was able to reach a certain viscosity all the delayed breaker was then able to break the fluid to reduce the viscosity to a reasonably low level allowing the fluid to flow out of the well.

FIG. 1 is a graph of a chemical system comprised of 1000 gallons of water, 0.4 gallons per thousand of an ammonium acetate acetic acid blend as a pH buffer, 6.25 gallons per thousand of guar polymer slurry having 4 pounds of guar per gallon of mineral oil, 4.0 gallons per thousand of a glycerol, ethylene glycol, and sorbitol mixture as a chelating agent, 0.2 gallons per thousand of organic phosphonic acid salt and methanol, 0.5 gallons per thousand of a non-emulsifier, 1.5 gallons per thousand of an amine including ethoxylated acetylenic diols, 4.0 gallons per thousand of a potassium hydroxide and potassium carbonate buffer to raise the pH, 1.0 gallons per thousand of ulexite slurry, 0.25 gallons per thousand of the 25% potassium borate solution, and 6 gallons per thousand of an alkyl mixture having aniline, ethylene glycol, propanel sulfonic acid, pyridinium salt, citric acid, and dipropylene glycol methyl ether. In FIG. 1 line 10 represents the temperature of the mixture as it moves up from roughly room temperature to 160° F. Line 12 represents the viscosity of the mixture over time without any breaker. As can be seen the viscosity of the mixture once it reaches 160° F. drops from about 2000 to about 1000 in about 30 minutes but then remains at about 1000 for the duration of the test. Line 14 represents the viscosity of the mixture over time having 1 pound per thousand gallons of a heavily encapsulated breaker such as ammonium per sulfate or sodium per sulfate. As can be seen the viscosity of the mixture once it reaches 160° F. drops from about 2000 to about 1000 in about 30 minutes but then the viscosity continues to steadily decrease for another 20 minutes to about 250 where it remains for the duration of the test. Line 16 represents the viscosity of the mixture over time having 2 pounds per thousand gallons of a heavily encapsulated breaker such as ammonium per sulfate or sodium per sulfate. As can be seen the viscosity of the mixture once it reaches 160° F. drops from about 2000 to about 1000 in about 30 minutes but then the viscosity continues to steadily decrease for another 10 minutes to about 250. However the mixture then continues to decrease in viscosity for the next 15 minutes until it reaches a viscosity of about 125 where it remains for the duration of the test. Lines 16 and 20 respectively represent the viscosity of the mixture over time having 3 pounds per thousand gallons of a heavily encapsulated breaker and 4 pounds per thousand gallons of a heavily encapsulated breaker such as ammonium per sulfate or sodium per sulfate. As can be seen the viscosity of the mixtures once they reach 160° F. drops from about 2000 to about 1000 in about 30 minutes but then the viscosity continues to steadily decrease for another 5 minutes to about 250. However the mixtures then continues to decrease in viscosity until it reaches a viscosity of about 100 where it remains for the duration of the test.

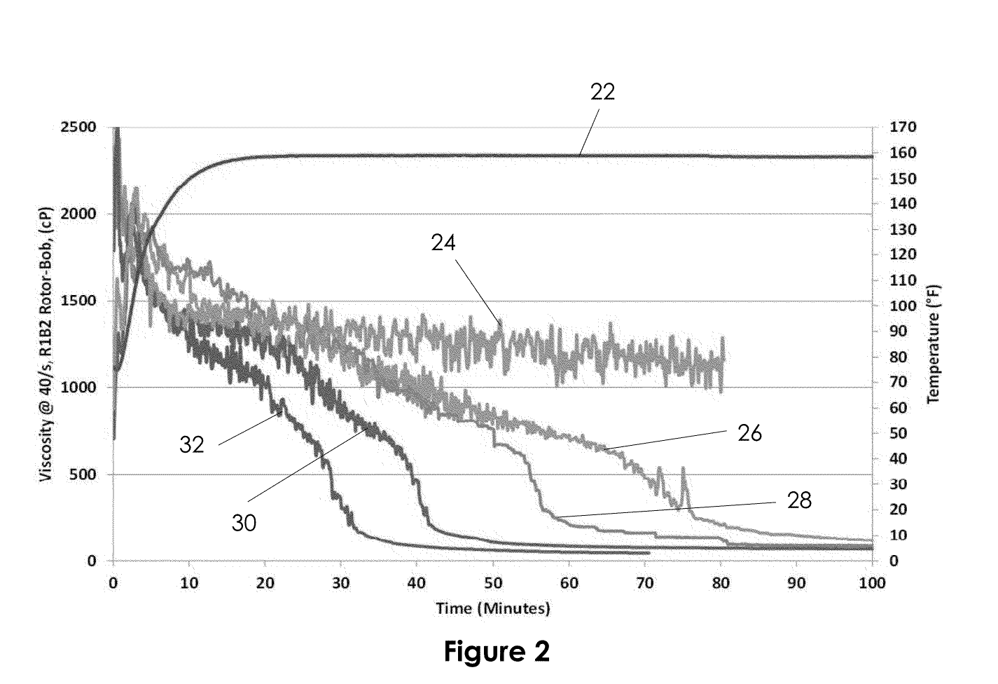

FIG. 2 is a graph of a chemical system comprised of 1000 gallons of water, 1.0 gallons per thousand of an ammonium acetate acetic acid blend as a pH buffer, 25.0 gallons per thousand of guar polymer slurry having 4 pounds of guar per gallon of mineral oil, 3.5 gallons per thousand of a glycerol, ethylene glycol, and sorbitol mixture as a chelating agent, 1.0 gallons per thousand of a non-emulsifier, 5.5 gallons per thousand of a potassium hydroxide and potassium carbonate buffer to raise the pH, 1.0 gallons per thousand of ulexite slurry, and 0.25 gallons per thousand of the 25% potassium borate solution. In FIG. 2 line 22 represents the temperature of the mixture as it moves up from roughly room temperature to 160° F. Line 24 represents the viscosity of the mixture over time without any breaker. As can be seen the viscosity of the mixture begins to decrease from an average maximum of about 2000 to about 1250 in about 15 minutes as the temperature reaches 160° F. in approximately the same time. Line 26 represents the viscosity of the mixture over time having 1 pound per thousand gallons of a heavily encapsulated breaker such as ammonium per sulfate or sodium per sulfate. As can be seen the viscosity of the mixture as it reaches 160° F. drops from about 2000 to about 125 in about 80 minutes. Line 28 represents the viscosity of the mixture over time having 2 pounds per thousand gallons of a heavily encapsulated breaker such as ammonium per sulfate or sodium per sulfate. As can be seen the viscosity of the mixture as it reaches 160° F. drops from about 2000 to about 600 in about 55 minutes but then the viscosity rapidly decreases to about 250 in less than five minutes and then continues to steadily decrease to a viscosity of about 100 at about 82 minutes after the test began. Line 30 represents the viscosity of the mixture over time having 3 pounds per thousand gallons of a heavily encapsulated breaker such as ammonium per sulfate or sodium per sulfate. As can be seen the viscosity of the mixture as it reaches 160° F. drops from about 2000 to about 600 in about 38 minutes but then the viscosity rapidly decreases to about 250 in less than five minutes and then continues to steadily decrease to a viscosity of about 100 at about 50 minutes after the test began. Line 32 represents the viscosity of the mixture over time having 4 pounds per thousand gallons of a heavily encapsulated breaker such as ammonium per sulfate or sodium per sulfate. As can be seen the viscosity of the mixture as it reaches 160° F. drops from about 2000 to about 200 in about 32 minutes and continues to taper off to a viscosity of about 100 at about 35 minutes after the test began.

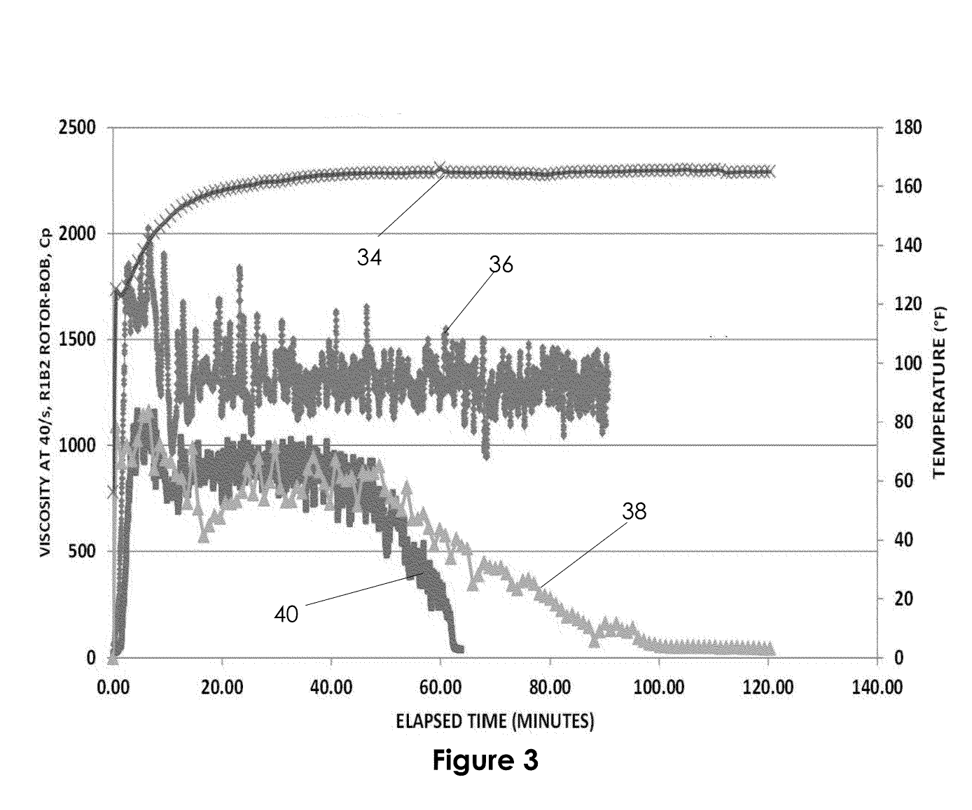

FIG. 3 is a graph of a chemical system comprised of 1000 gallons of water, 0.5 gallons per thousand of an ammonium acetate acetic acid blend as a pH buffer, 6.25 gallons per thousand of guar polymer slurry having 4 pounds of guar per gallon of mineral oil, 0.5 gallons per thousand of a non-emulsifier, 1.5 gallons per thousand of an amine including ethoxylated acetylenic diols, 5.0 gallons per thousand of a potassium hydroxide and potassium carbonate buffer to raise the pH, and 2.0 gallons per thousand of ulexite slurry. In FIG. 3 line 34 represents the temperature of the mixture as it moves up from roughly room temperature to 160° F. Line 36 represents the viscosity of the mixture over time without any breaker. As can be seen the viscosity of the mixture once initially reaches about 1750 and then drops to about 1300 where it remains for the duration of the test. Line 38 represents the viscosity of the mixture over time having 3 pounds per thousand gallons of a heavily encapsulated breaker such as ammonium per sulfate or sodium per sulfate. As can be seen the viscosity of the mixture reaches a viscosity of about 1000 where it remains until about 45 minutes into the test and the test that it begins to taper off to a viscosity of about 100 at about 90 minutes into the test where it remains. Line 40 represents the viscosity of the mixture over time having four pounds per thousand gallons of a heavily encapsulated breaker such as ammonium per sulfate or sodium per sulfate. As can be seen the viscosity of the mixture reaches a viscosity of about 1000 where it remains until about 45 minutes into the test and then begins to taper off to a viscosity of about 100 at about 62 minutes where it remains.

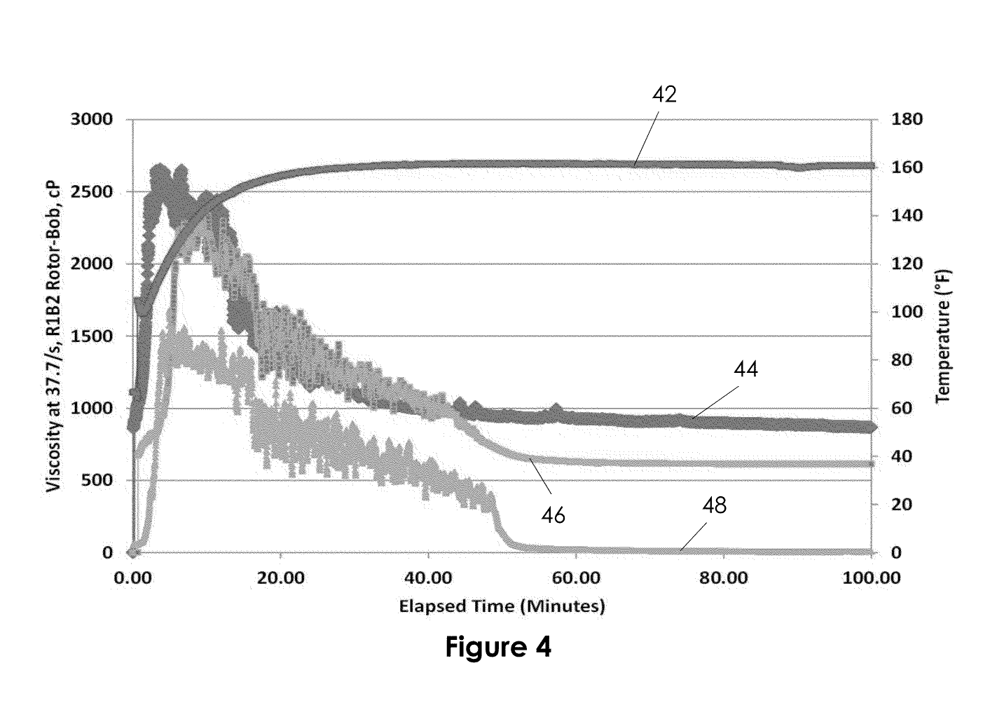

FIG. 4 is a graph of a chemical system comprised of 1000 gallons of water, 0.5 gallons per thousand of an ammonium acetate acetic acid blend as a pH buffer, 6.25 gallons per thousand of guar polymer slurry having 4 pounds of guar per gallon of mineral oil, 4.0 gallons per thousand of a glycerol, ethylene glycol, and sorbitol mixture as a chelating agent, 0.5 gallons per thousand of a non-emulsifier, 4.0 gallons per thousand of a potassium hydroxide and potassium carbonate buffer to raise the pH, 1.0 gallons per thousand of ulexite slurry, and 0.25 gallons per thousand of the 25% potassium borate solution. In FIG. 4 line 42 represents the temperature of the mixture as it moves up from roughly room temperature to 160° F. Line 44 represents the viscosity of the mixture over time without any breaker. As can be seen the viscosity of the mixture drops from about 2500 to about 1000 in about 45 minutes where more or less remains slightly tapering off to about 850 at the end of the test at 100 minutes. Line 46 represents the viscosity of the mixture over time having 1 pound per thousand gallons of a heavily encapsulated breaker such as ammonium per sulfate or sodium per sulfate. As can be seen, the viscosity of the mixture drops from about 2250 to about 1000 in about 40 minutes but then the viscosity drops off fairly sharply to about 750 where it remains for the duration of the test. Line 48 represents the viscosity of the mixture over time having to pounds per thousand gallons of a heavily encapsulated breaker such as ammonium per sulfate or sodium per sulfate. As can be seen, the viscosity of the mixture drops from about 1400 to about 250 in about 40 minutes but then the viscosity drops off fairly sharply to essentially zero where it remains for the duration of the test.

This list of additives is not exhaustive and additional additives known to those skilled in the art that are not specifically cited below fall within the scope of the invention

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A well treatment material method comprising:
lowering a pH of a finished water,
hydrating a viscosifier with the finished water,
chelating a boron present in the finished water and the viscosifier,
raising a pH of the finished water and the viscosifier, and
adding a slowly soluble borate to the finished water and the viscosifier.

2. The method of claim 1 wherein, the step of lowering the pH consists of lowering the pH to below 7.

3. The method of claim 1 wherein, the step of lowering the pH consists of lowering the pH to between 6 and 6.5.

4. The method of claim 1 wherein, the step of raising the pH consists of raising the pH to above 7.

5. The method of claim 1 wherein, the step of raising the pH consists of raising the pH to between 9.5 and 12.

6. The method of claim 1 wherein, the step of raising the pH consists of raising the pH to between 10 and 11.

7. The method of claim 1 wherein, the slowly soluble borate is ulexite.

8. The method of claim 1 wherein, a fast crosslinker is added with the slowly soluble borate.

9. The method of claim 8 wherein, a fast crosslinker is a borax solution.

10. The method of claim 8 wherein, a fast crosslinker is potassium borate.
